(19) United States
(12) Patent Application Publication
(10) Pub. No.: US 2013/0132425 A1
(43) Pub. Date: May 23, 2013

(54) QUERY DEFINITION APPARATUS AND METHOD FOR MULTI-TENANT

(71) Applicants: Moon-Young CHUNG, Daejeon (KR); Kyung-Ah YANG, Daejeon (KR); Hee-Sun WON, Daejeon (KR); Sung-Jin HUR, Daejeon (KR); Kyong-I KU, Daejeon (KR)

(72) Inventors: Moon-Young CHUNG, Daejeon (KR); Kyung-Ah YANG, Daejeon (KR); Hee-Sun WON, Daejeon (KR); Sung-Jin HUR, Daejeon (KR); Kyong-I KU, Daejeon (KR)

(73) Assignee: Electronics and Telecommunications Research Institute, Daejeon (KR)

(21) Appl. No.: 13/611,935

(22) Filed: Sep. 12, 2012

(30) Foreign Application Priority Data
Nov. 21, 2011 (KR) 10-2011-0121801

(51) Int. Cl. G06F 17/30

(52) U.S. Cl. 707/769; 707/E17.014; 707/E17.044

(57) ABSTRACT

The present invention relates to a query definition apparatus and method for multi-tenant. The query definition apparatus includes a schema generation unit for, when a tenant accesses a Software as a Service (SaaS) system, generating a basic schema required to execute an application program requested by the tenant on a SaaS platform. A schema editing unit edits the basic schema in response to a request of a tenant manager. A query definition unit is configured to, when the basic schema is edited, provide a query definition interface required to define queries for the edited schema to the tenant manager, and define a query statement by extracting corresponding queries depending on manipulation of the query definition interface.

### CROSS REFERENCE TO RELATED APPLICATION

This application claims the benefit of Korean Patent Application No. 10-2011-0121801, filed on Nov. 21, 2011, which is hereby incorporated by reference in its entirety into this application.

### BACKGROUND OF THE INVENTION

1. Technical Field

The present invention relates generally to a query definition apparatus and method for multi-tenant and, more particularly, to a query definition apparatus and method for multi-tenant, which provide an interface for defining queries when the schema of a Software as a Service (SaaS) platform is changed, and then complete a query statement for the changed schema.

2. Description of the Related Art

In a Software as a Service (SaaS) platform, a plurality of logical schemata used by multiple tenants in application programs are mapped to and used by a single physical schema shared by the multiple tenants. In this case, in a SaaS system, various methods are used to support an extensible schema so that multiple tenants can change and use the schema in conformity with their own requirements.

Meanwhile, in order to allow multiple tenants to use an extended schema of an application, queries must also be defined together in conformity with the extended schema.

As an example, Japanese Unexamined Patent Application Publication No. 2009-282777 discloses technology related to a system that provides an application program for providing a multi-tenant application, wherein a user defines a user application or an extended application.

However, when a tenant manager defines queries suitable for an extended schema using a language that is usable in a SaaS system, a method using a language to define queries is not easily implemented. Further, since such a query must be defined differently according to the logical schema subordinate to the tenant, it is not easy for the tenant manager to understand the logical meaning, that is, the semantic meaning of the schema.

### SUMMARY OF THE INVENTION

Accordingly, the present invention has been made keeping in mind the above problems occurring in the prior art, and an object of the present invention is to provide a query definition apparatus and method for multi-tenant, which can easily define queries for an extended schema even if a tenant manager does not know a language or a logical schema that are used in a SaaS platform.

Another object of the present invention is to provide a query definition apparatus and method for multi-tenant, which provide a query definition interface in which queries are defined for respective items to a tenant manager, and then enable a query statement to be automatically completed by allowing the tenant manager to only select a specific item.

In accordance with an aspect of the present invention to accomplish the above objects, there is provided a query definition apparatus for multi-tenant, including a schema generation unit for, when a tenant accesses a Software as a Service (SaaS) system, generating a basic schema required to execute an application program requested by the tenant on a SaaS platform, a schema editing unit for editing the basic schema in response to a request of a tenant manager; and a query definition unit for, when the basic schema is edited, providing a query definition interface required to define queries for the edited schema to the tenant manager, and defining a query statement by extracting corresponding queries depending on manipulation of the query definition interface.

Preferably, the query definition interface may be configured such that queries corresponding to respective items implemented in the query definition interface are defined.

Preferably, the query definition interface may include items required to define queries for at least one of extraction of a database, selection of a database, and establishment of a relationship between objects in the SaaS platform.

Preferably, the query definition unit may generate a query statement by extracting queries corresponding to an item selected by the tenant manager, and converts the query statement into a language format used in the SaaS platform.

Preferably, the query definition unit may convert the query statement into a Structured Query Language (SQL) format.

Preferably, the query definition apparatus may further include a storage unit for storing metadata about the query statement completed by the query definition unit in accordance with the edited schema.

In accordance with another aspect of the present invention to accomplish the above objects, there is provided a query definition method for multi-tenant, including when a tenant accesses a Software as a Service (SaaS) system, generating a basic schema required to execute an application program requested by the tenant on a SaaS platform, editing the basic schema in response to a request of a tenant manager, when the basic schema is edited, providing a query definition interface required to define queries for the edited schema to the tenant manager, and defining a query statement by extracting corresponding queries depending on manipulation of the query definition interface.

Preferably, the query definition interface may be configured such that queries corresponding to respective items implemented in the query definition interface are defined.

Preferably, the query definition interface comprises items required to define queries for at least one of extraction of a database, selection of a database, and establishment of a relationship between objects in the SaaS platform.

Preferably, the defining the query statement may include generating a query statement by extracting queries corresponding to an item selected by the tenant manager, and converting the query statement into a language format used in the SaaS platform.

Preferably, the converting may be configured to convert the query statement into a Structured Query Language (SQL) format.

Preferably, the query definition method may further include storing metadata about the query statement completed at the defining the query statement in accordance with the edited schema.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of a query definition apparatus for multi-tenant according to the present invention;

FIG. 2 is a block diagram showing the detailed configuration of the query definition unit of the query definition apparatus for multi-tenant according to the present invention;

FIG. 3 is a diagram illustrating an embodiment of a query definition interface provided by the query definition apparatus for multi-tenant according to the present invention;

FIGS. 4 and 5 are diagrams referred to in illustrating an embodiment in which a query is defined via the query definition interface according to the present invention; and

FIG. 6 is a flowchart showing the flow of the operations of a query definition method for multi-tenant according to the present invention.

### DESCRIPTION OF THE PREFERRED EMBODIMENTS

A Software as a Service (SaaS) system applied to the present invention stores data about multiple tenants in a single database (DB) in a platform, but supports multi-tenant environments so that different logical schemata can be used in conformity with the requirements of respective tenants. That is, the SaaS system supports multi-tenant environments so that multiple tenants that use a physically shared schema can use their own logical schemata.

For this, the present invention is intended to propose a query definition apparatus and method for multi-tenant so that even a user who does know a DB query language or a programming language can easily understand query semantics and define queries.

Hereinafter, embodiments of the present invention will be described with reference to the attached drawings.

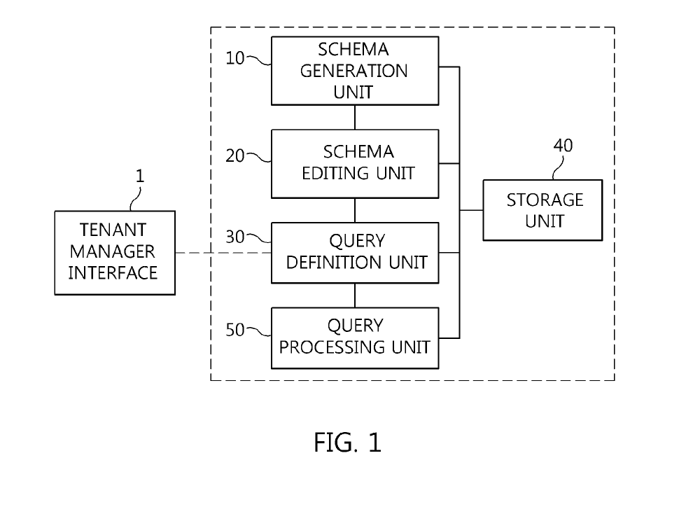

FIG. 1 is a block diagram showing the configuration of a query definition apparatus for multi-tenant according to the present invention.

As shown in FIG. 1, the query definition apparatus for multi-tenant according to the present invention includes a schema generation unit 10, a schema editing unit 20, a query definition unit 30, and a storage unit 40.

The schema generation unit 10 generates a basic schema required to execute an application program, requested by a tenant, on a SaaS platform when the tenant accesses a SaaS system.

In other words, when an object required to execute the application program is generated on the SaaS platform, user pages, business logic, and a schema related to the object are automatically generated. In this case, the generated user pages include a list page for indicating records suitable for the schema in the form of a table and an editing page for enabling the records to be edited. For the business logic, basic queries for the schema are generated, and for the schema, fields defined in conformity with the object are generated.

Therefore, the schema generation unit 10 defines the basic schema in conformity with the object, and generates the fields as defined.

The schema editing unit 20 performs editing such as by extending or deleting the basic schema generated by the schema generation unit 10 in response to the request of the tenant manager. That is, when a request to extend the schema is received from the tenant manager, the requested extension schema is defined in addition to the basic schema, and fields are additionally generated according to the defined extension schema.

Of course, when a deletion request is received, a field corresponding to the schema requested to be deleted is deleted from the fields generated in conformity with the basic schema.

The query definition unit 30 defines queries according to the basic schema if the basic schema has been generated. Of course, queries for the basic schema are automatically generated when the object is generated.

Meanwhile, the query definition unit 30 provides a query definition interface to the interface of the tenant manager so as to define queries for an edited schema when the schema editing unit 20 edits the basic schema in response to the request of the tenant manager.

In this case, in the query definition interface, queries corresponding to respective items implemented in the query definition interface are defined. Further, the query definition interface includes items required to define a queries for at least one of the extraction of a DB, the selection of a DB, and the establishment of a relationship between objects in the SaaS platform.

Therefore, when the specific item of the query definition interface is selected by the tenant manager, the query definition unit 30 extracts queries corresponding to the selected item and then generates a query statement.

In this case, the query statement completed by the query definition unit 30 in accordance with the edited schema is stored in the storage unit 40 in the format of metadata.

The query definition apparatus according to the present invention may further include a query processing unit 50 for processing the queries stored in the storage unit 40 when an application program is executed on the SaaS platform. Therefore, when the application program is executed on the SaaS platform in response to the request of the tenant, the query processing unit 50 can process the query statement corresponding to the extended schema by calling metadata stored in the storage unit 40.

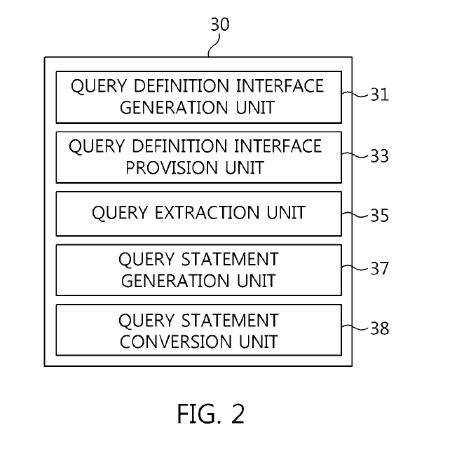

FIG. 2 is a block diagram showing the detailed configuration of the query definition unit of the query definition apparatus for multi-tenant according to the present invention.

As shown in FIG. 2, the query definition unit 30 according to the present invention includes a query definition interface generation unit 31, a query definition interface provision unit 33, a query extraction unit 35, a query statement generation unit 37, and a query statement conversion unit 38.

The query definition interface generation unit 31 generates interface items for respective fields defined in editable schemata so as to define queries for an edited schema, and defines queries corresponding to respective items.

The query definition interface provision unit 33 provides the query definition interface generated by the query definition interface generation unit 31 to a tenant manager when a request to edit a basic schema is received from the tenant manager.

Therefore, the tenant manager selects items corresponding to the editing schema using the query definition interface displayed on the interface screen of the tenant manager. The query extraction unit 35 individually extracts queries corresponding to the selected items when the tenant manager selects the items corresponding to the editing schema via the query definition interface.

The query statement generation unit 37 generates an additional query statement by combining the individual queries extracted by the query extraction unit 35, and then completes a final query statement by applying the additionally generated query statement to a previous query statement generated in accordance with the basic schema.

Of course, when languages used in the generated query statement and the SaaS platform are different from each other, the query statement conversion unit 38 converts the generated query statement into a query statement expressed in a language used in the SaaS platform. For example, the query statement conversion unit 38 converts the generated query statement into a Structured Query Language (SQL) format.

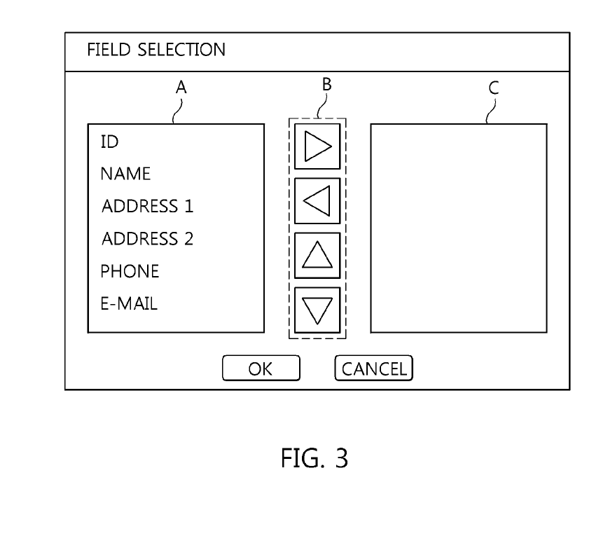

FIG. 3 is a diagram illustrating an embodiment of a query definition interface provided by the query definition apparatus for multi-tenant according to the present invention.

Referring to FIG. 3, the query definition unit provides a query definition interface required to define queries corresponding to an edited schema to a tenant manager when a schema is edited in response to the request of the tenant manager. FIG. 3 shows an embodiment of the query definition interface provided to the tenant manager.

In detail, the query definition interface of FIG. 3 shows an example of the selection of a field required to generate queries for an edited schema in a customer information control application program.

Screens implemented in a field selection interface include a first screen A on which basically selectable field items are displayed, a button unit B which is required to perform manipulation such as adding or deleting an item selected from among the field items displayed on the first screen A, and a second screen C on which a field item selected by the manipulation of the button unit is displayed.

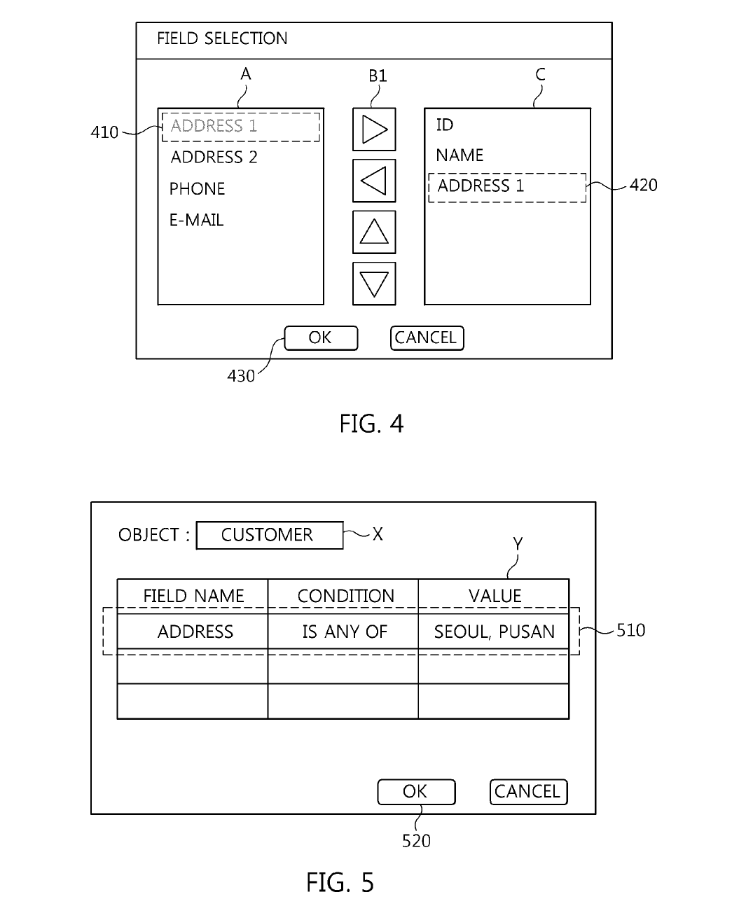

The operation of defining queries via the query definition interface of FIG. 3 will be described with reference to FIG. 4.

On the second screen of the query definition interface for ‘field selection’ shown in FIG. 4, previously selected fields ‘Id’ and ‘Name’ are displayed. In this case, when the tenant manager selects an ‘Address1’ item 410 from among field items displayed on the first screen A, and manipulates an addition button B1, an ‘address1’ item 420 is added to the second screen C.

In this case, the tenant manager may move the location of a field item selected from among the items displayed on the second screen depending on the manipulation of up/down buttons and may move back the location of the selected field item from the second screen to the first screen using a left direction button. An embodiment related to this function is omitted here.

When the selection of the fields has been finally completed, the tenant manager completes the selection of fields for query definition by manipulating an ‘OK’ button 430.

In this case, the query definition apparatus of the present invention converts fields selected by the user into SQL statements. That is, the query definition apparatus extracts related items, such as a vender code, vender name, and handling item (flex), so as to generate queries for the ‘Address1’ item 420 added to the second screen C of the query definition interface from the storage unit, combines the extracted queries, and then generates the following query statement

Select Vendor_code, Vendor_name, flex1, . . .
From Vendor_table
Where . . .

In the SaaS platform, a query statement is stored according to the language used in the platform. However, when the query statement is analyzed as an SQL statement, the selected fields are inserted into a SELECT clause, so that the queries can be processed as defined by the tenant manager.

FIG. 5 illustrates a second embodiment, which shows an example in which the tenant manager generates a query statement for setting conditions for an object.

As shown in FIG. 5, query semantics for assigning conditions to fields correspond to the selection of a DB. That is, this is identical to a condition inserted into a WHERE clause of a DB query, and is a query used when only records satisfying a certain condition are desired to be selected from a relevant page.

As an example, as shown in FIG. 5, the tenant manager may set a condition for the address of a ‘customer’ object via the query definition interface provided by the query definition apparatus.

In this case, the tenant manager sets the condition to the case where ‘Address’ is ‘Seoul’ or ‘Pusan’ as shown in ‘510’, and manipulates an ‘OK’ button 520, thus completing the query definition operation of setting conditions.

In this case, the query definition apparatus according to the present invention generates a query statement by extracting queries corresponding to the ‘Address1’ item 420 added to the second screen C of the query definition interface.

As an example, the query definition apparatus generates a query statement such as “Address is equal to ‘Seoul’ or ‘Pusan’” depending on the conditions input via the query definition interface, and adds the generated query statement to a query statement that was previously defined, thus completing the following query statement.

Select a, b, c, . . . , flex1, flex2, . . . , flex N
From Customer
Where Address = ‘Seoul’ or ‘Pusan’

In addition to the embodiments shown in FIGS. 4 and 5, the query definition apparatus provides various types of query definition interfaces, such as for establishing relationships between objects, implementing various types of join operations, setting mathematical functions such as MAX and COUNT, and making sub-queries, to the tenant manager. The tenant manager may define the corresponding queries via the query definition interfaces. With regard to this, embodiments of the query definition interfaces provided by the query definition apparatus will be omitted.

Here, the establishment of relationships between objects denotes the establishment of relationships such as 1:1, 1:N, and N:N between objects, and has the semantic meaning of the join operation of SQL queries.

For example, the query definition apparatus may establish a relationship between ode_fta and ode_process depending on the manipulation of the query definition interfaces as follows.

Select a, b, c, . . . , flex1, flex2, . . . , flex N
From ode_fta, ode_process
Where ode_fta.fta_code = ode_process.fta_code

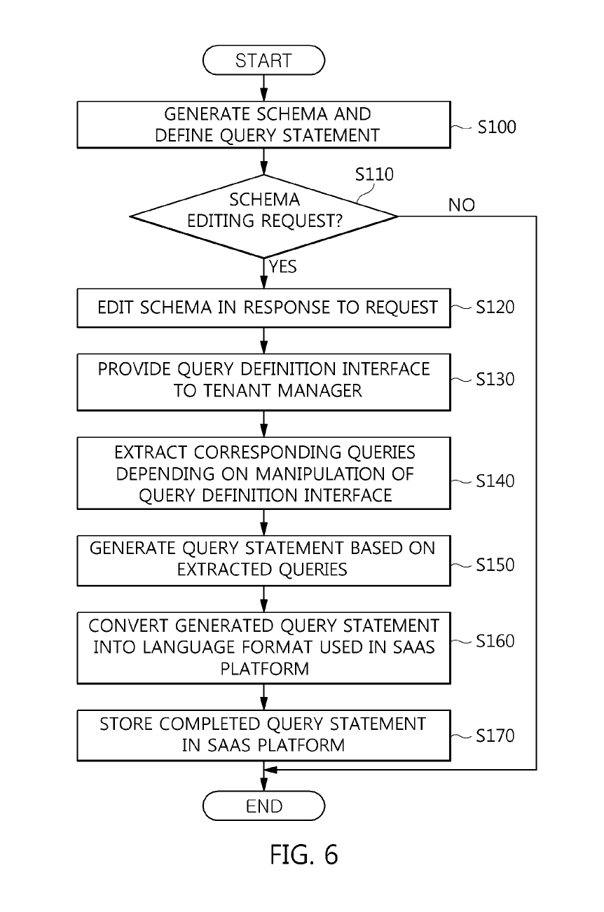

FIG. 6 is a flowchart showing the flow of the operations of a query definition method for multi-tenant according to the present invention.

As shown in FIG. 6, the query definition apparatus according to the present invention generates a basic schema required to execute an application program requested by a tenant on a SaaS platform when the tenant accesses a SaaS system. In this case, a query statement corresponding to the basic schema is defined together at step S100.

When an editing request such as for the extension or deletion of the schema is received from the tenant manager at step S110, the basic schema is extended or deleted in response to the editing request of the tenant manager at step S120.

Further, in order to define queries for the schema edited at step S120, a query definition interface is provided to the tenant manager at step S130.

In this case, the tenant manager may add or delete a field, set the conditions of a selected field, or establish a relationship between objects via the query definition interface and may also define queries such as various different types of join operations, mathematical functions, and sub-queries, depending on the implementation of the interface.

Therefore, the query definition apparatus extracts queries corresponding to the items that have been selected and manipulated depending on the manipulation of the query definition interface, provided at step S130, at step S140, and generates a query statement based on the extracted queries at step S150. In this case, the query definition apparatus completes a final query statement by converting the query statement generated at step S150 into a language format used in the SaaS platform at step S160. The completed query statement is stored in the SaaS platform at step S170. The query statement completed at step S170 is stored in the storage unit in the format of metadata.

According to the present invention, there is an advantage in that even if a tenant manager does not know a language or a logical schema used in a SaaS platform, a query definition interface in which queries for respective items are defined is provided to the tenant manager, so that the tenant manager can easily define queries for an extended schema.

Further, the present invention is advantageous in that automatically completed queries are stored as the metadata of each tenant, so that when a user calls a page, the metadata of a corresponding tenant is queried, and queries suitable for the tenant are processed, thus effectively supporting multiple tenants in a low-cost SaaS platform having a single physical schema.

As described above, although the preferred embodiments of the query definition apparatus and method for multi-tenant according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. A query definition apparatus for multi-tenant, comprising:
a schema generation unit for, when a tenant accesses a Software as a Service (SaaS) system, generating a basic schema required to execute an application program on a SaaS platform, the application program requested by the tenant;
a schema editing unit for editing the basic schema in response to a request of a tenant manager; and
a query definition unit for, when the basic schema is edited, providing a query definition interface required to define queries for the edited schema to the tenant manager, and defining a query statement by extracting corresponding queries depending on manipulation of the query definition interface.

2. The query definition apparatus of claim 1, wherein the query definition interface is configured such that queries corresponding to respective items implemented in the query definition interface are defined.

3. The query definition apparatus of claim 2, wherein the query definition interface comprises items required to define queries for at least one of extraction of a database, selection of a database, and establishment of a relationship between objects, in the SaaS platform.

4. The query definition apparatus of claim 1, wherein the query definition unit generates the query statement by extracting queries corresponding to an item selected by the tenant manager, and converts the query statement into a language format used in the SaaS platform.

5. The query definition apparatus of claim 4, wherein the query definition unit converts the query statement into a Structured Query Language (SQL) format.

6. The query definition apparatus of claim 1, further comprising a storage unit for storing metadata about the query statement completed by the query definition unit in accordance with the edited schema.

7. A query definition method for multi-tenant, comprising:
when a tenant accesses a Software as a Service (SaaS) system, generating a basic schema required to execute an application program on a SaaS platform the application program requested by the tenant;
editing the basic schema in response to a request of a tenant manager;
when the basic schema is edited, providing a query definition interface required to define queries for the edited schema to the tenant manager; and
defining a query statement by extracting corresponding queries depending on manipulation of the query definition interface.

8. The query definition method of claim 7, wherein the query definition interface is configured such that queries corresponding to respective items implemented in the query definition interface are defined.

9. The query definition method of claim 8, wherein the query definition interface comprises items required to define queries for at least one of extraction of a database, selection of a database, and establishment of a relationship between objects in the SaaS platform.

10. The query definition method of claim 7, wherein the defining the query statement comprises:
generating the query statement by extracting queries corresponding to an item selected by the tenant manager; and
converting the query statement into a language format used in the SaaS platform.

11. The query definition method of claim 10, wherein the converting is configured to convert the query statement into a Structured Query Language (SQL) format.

12. The query definition method of claim 7, further comprising storing metadata about the query statement completed at the defining the query statement in accordance with the edited schema.
